(19) United States
(12) Patent Application Publication
(10) Pub. No.: US 2007/0289300 A1
(43) Pub. Date: Dec. 20, 2007

(54) HEAT POWER DEVICE

(76) Inventor: Pao-Lung Lin, Taipei (TW)

Correspondence Address: HDSL, 4331 STEVENS BATTLE LANE, FAIRFAX, VA, 22033, US

(21) Appl. No.: 11/680,824

(22) Filed: Mar. 1, 2007

(30) Foreign Application Priority Data
Jun. 15, 2006 (TW) 095210439

(51) Int. Cl. F02G 1/043

(52) U.S. Cl. 60/517

(57) ABSTRACT

A heat power device includes a Stirling engine and at least one heat pipe, in which the heat pipe is used to drive the Stirling engine to operate. A piston seat of the Stirling engine has a surface to be heated, and the condensed end of the heat pipe is brought into contact with the surface to be heated. At least one heat pipe is used to absorb single heat source or a plurality of heat pipes are used to absorb a plurality of heat sources. The heat generated by the heat source is transferred to the Stirling engine. In this way, after the heat pipe is brought into contact with the heat source, the Stirling engine can be driven to operate.

### BACKGROUND OF THE INVENTION

1. Field of the Invention

The present invention relates to a power device, and in particular to a heat power device in which a heat pipe is used to transfer the heat to a Stirling engine for operating the Stirling engine.

2. Description of Prior Art

The Stirling engine is an external-combustion reciprocal engine constituted of a piston and an ejector. The piston and the ejector operate in the interior of the Stirling engine. When the internal air is heated up, the principle of expanding at high temperature is utilized to drive the piston to operate. The ejector delivers the heated air to a cooling zone where the air is cooled down, thereby to cause the piston to return its original position. In this way, the internal air is heated again to repeat the operation.

The heat pipe is a heat-transferring element having working fluid and capillary structure therein. The heat pipe is constituted of an end to be heated and a condensed end far from the end to be heated. After the end to be heated is heated up, since the interior thereof is vacuum, the working fluid therein is also heated up and changes from the liquid phase to the vapor phase. At this time, the vapor-phase working fluid rapidly transfers the heat to the condensed end. After the working fluid is cooled down to return the liquid phase, it flows back to the end to be heated via the capillary structure.

Further, the current heat-dissipating device of an electronic heat-generating element is mostly an electric fan. However, the operation of the electronic heat-generating element has already wasted a lot of electricity. If the electric fan is used to perform the heat dissipation, more energy will be consumed. In view of this, the present invention combines the Stirling engine with the heat pipe and uses the heat generated by the electronic heat-generating element to drive the Stirling engine. Therefore, the waste heat generated by the heat-generating element itself is used to facilitate the heat dissipation thereof, thereby to achieve the objects of saving energy and using waste heat.

### SUMMARY OF THE INVENTION

The present invention is to provide a heat power device, which can save energy and utilize the waste heat. The present invention uses at least one heat pipe to absorb single heat source or uses a plurality of heat pipes to absorb a plurality of heat sources, thereby to transfer the heat generated by the heat source to the Stirling engine for operating the Stirling engine.

In order to achieve the above objects, the present invention provides a heat power device comprising a Stirling engine and at least one heat pipe. The Stirling engine has a piston seat. The interior of the piston seat is formed into a hollow chamber for accommodating a piston therein. The piston is connected with a connecting-rod means. The connecting-rod means is further connected to a crankshaft. With this arrangement, when the piston moves reciprocally in the chamber, the connecting-rod means is driven to rotate the crankshaft. The heat pipe has an end to be heated and a condensed end far from the end to be heated. The piston seat has a surface to be heated. The condensed end of the heat pipe is brought into contact with the surface to be heated. In this way, after the end to be heated of the heat pipe is brought into contact with the heat source, the Stirling engine can be driven to operate.

### BRIEF DESCRIPTION OF THE DRAWINGS

FIG. 1 is a perspective view showing the external appearance of the present invention;

FIG. 2 is a rear view of the present invention;

FIG. 3 is a cross-sectional view taken along the line 3-3 in FIG. 2;

FIG. 4 is a schematic view showing that the present invention is applied to a heat dissipator; and

FIG. 5 is a partially cross-sectional view showing that the present invention is applied to a computer casing.

### DETAILED DESCRIPTION OF THE INVENTION

In order to make the Examiner to better understand the characteristics and technical contents of the present invention, a detailed description will be made with reference to the accompanying drawings. However, it should be understood that the drawings are illustrative only but not to limit the present invention thereto.

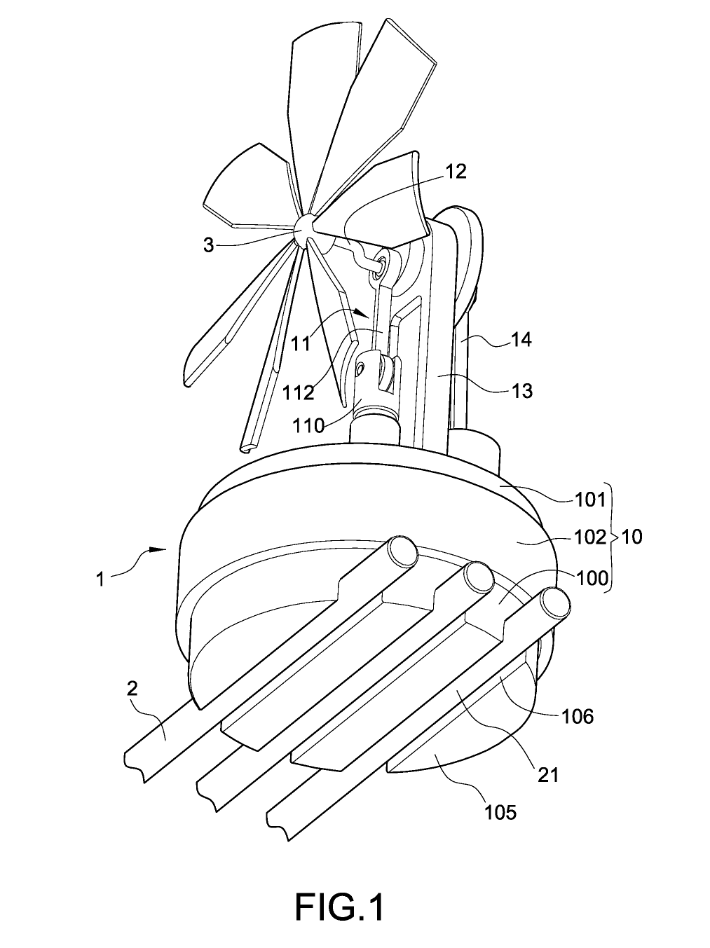

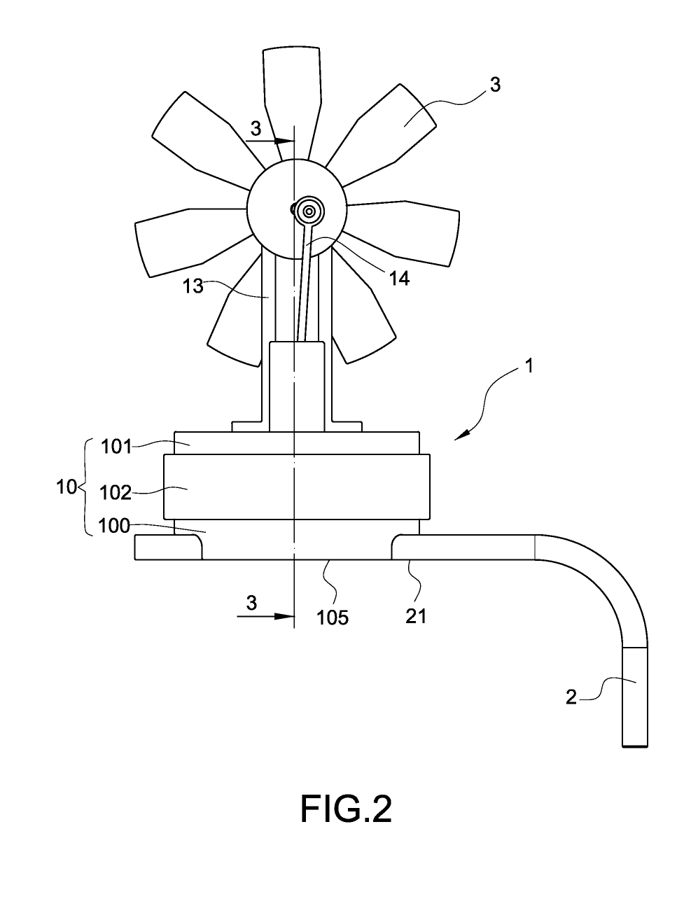

FIG. 1 is a perspective view showing the external appearance of the present invention, and FIG. 2 is a rear view thereof. The present invention provides a heat power device in which heat pipes 2 are used to transfer the heat to a Stirling engine 1 for operating the Stirling engine 1. The heat power device comprises a Stirling engine 1 and at least one heat pipe 2.

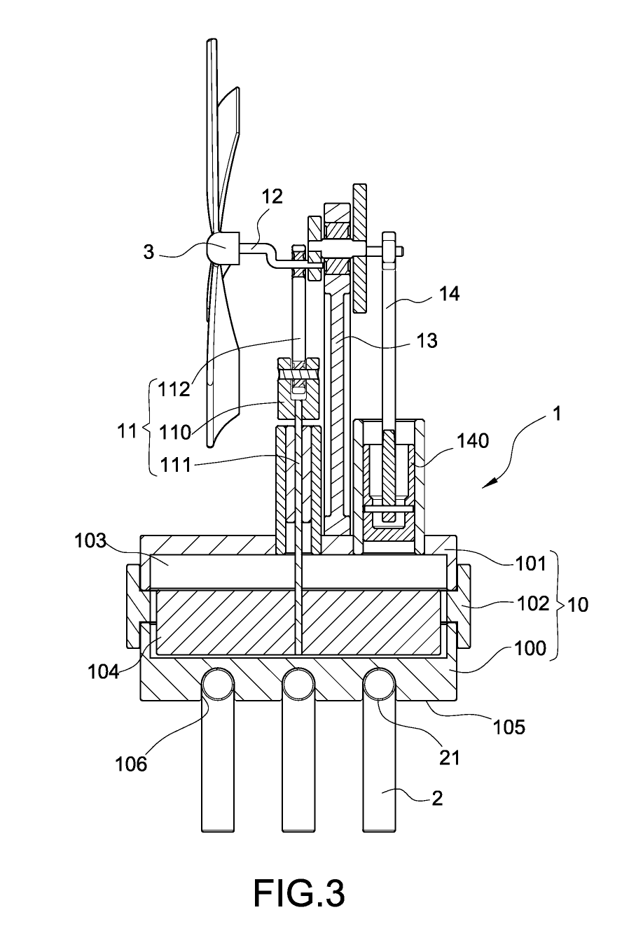

With reference to FIG. 3, the Stirling engine 1 has a hollow piston seat 10. The piston seat 10 is constituted of a base 100, an upper cover 101 and a sealing ring 102 provided between the base 100 and the upper cover 101. The interior of the piston seat 10 is formed into a hollow chamber 103 for accommodating a piston 104 therein. The piston seat 10 has a surface 105 to be heated. The surface 105 to be heated is located at one side out of the piston seat 10 (e.g. bottom surface).

The piston 104 is connected with a connecting-rod means 11. In this way, when the piston 104 moves reciprocally in the chamber 103 of the piston seat 10, the connecting-rod means 11 can be driven to operate. The connecting-rod means 11 comprises a shaft connector 110, a first connecting rod 111 and a second connecting rod 112. The shaft connector 110 is used to pivotably connecting the first and second connecting rods 111, 112 in such a way that the first connecting rod 111 is connected to the piston 104 while the second connecting rod 112 is connected to a crankshaft 12. When the piston 104 moves reciprocally in the chamber 103, the connecting-rod means 11 is driven to cause the rotation of the crankshaft 12. The crankshaft 12 is supported by means of a supporting arm 13 erected on the piston seat 10. On the rear side of the supporting arm 13, the crankshaft 12 is further connected to a crank 14. The crank 14 is used to drive an ejector 140 located above the chamber 103, thereby to form the above-mentioned Stirling engine 1.

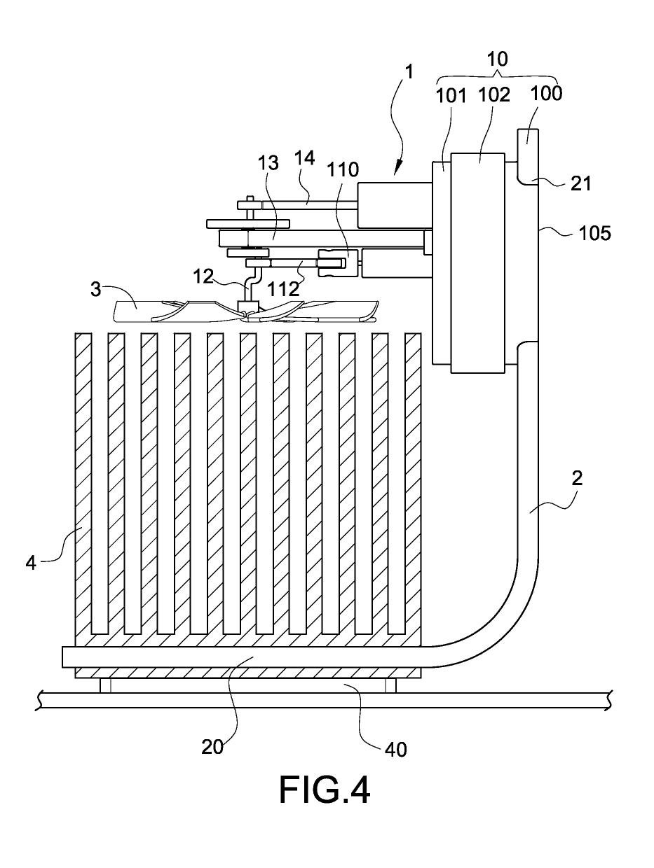

The heat pipe 2 is a heat-transferring element having working fluid and capillary structure therein. Each heat pipe 2 has an end 20 to be heated (FIG. 4) and a condensed end 21 far from the end 20 to be heated. The heat pipe 2 can be formed of a straight pipe or with an angled middle portion.

The present invention lies in that the condensed end 21 of each heat pipe 2 is brought into contact with the surface 105 to be heated of the piston seat 10 of the Stirling engine 1. In the embodiment of the present invention, the surface 105 to be heated is provided with a plurality of troughs 106 to correspond to the condensed end 21 of each heat pipe 2. In this way, the condensed end 21 of each heat pipe 2 is embedded into each trough 106 respectively, thereby to increase the contacting area between the condensed end 20 of the heat pipe 2 and the surface 105 to be heated. Therefore, when the end 20 to be heated of the heat pipe 2 is heated up, the thus-absorbed heat can be rapidly transferred to the condensed end 21. Further, the heat is used to drive the Stirling engine 1 to operate, thereby to achieve the object of driving the Stirling engine by heat power.

Therefore, with the above construction, the heat power device of the present invention can be obtained.

As shown in FIG. 4, the heat power device can be further applied to a heat dissipator 4. The heat dissipator 4 can perform the heat dissipation of an electronic heat-generating element 40 (e.g. CPU). With the end 20 to be heated of the heat pipe 2 of the heat power device penetrating through the heat dissipator 4, the heat dissipator 4 is thermally connected with the end 20 to be heated of the heat pipe 2. The heat generated by the heat-generating element 40 is absorbed by the end 20 to be heated of the heat pipe 2 and rapidly transferred to the condensed end 21 of the heat pipe 2, thereby to drive the Stirling engine 1 to operate. In this way, a blade 3 provided at the front end of the crankshaft 12 is driven to rotate, thereby to generate a wind power to facilitate the heat dissipation of the heat dissipator 4 and the heat-generating element 40.

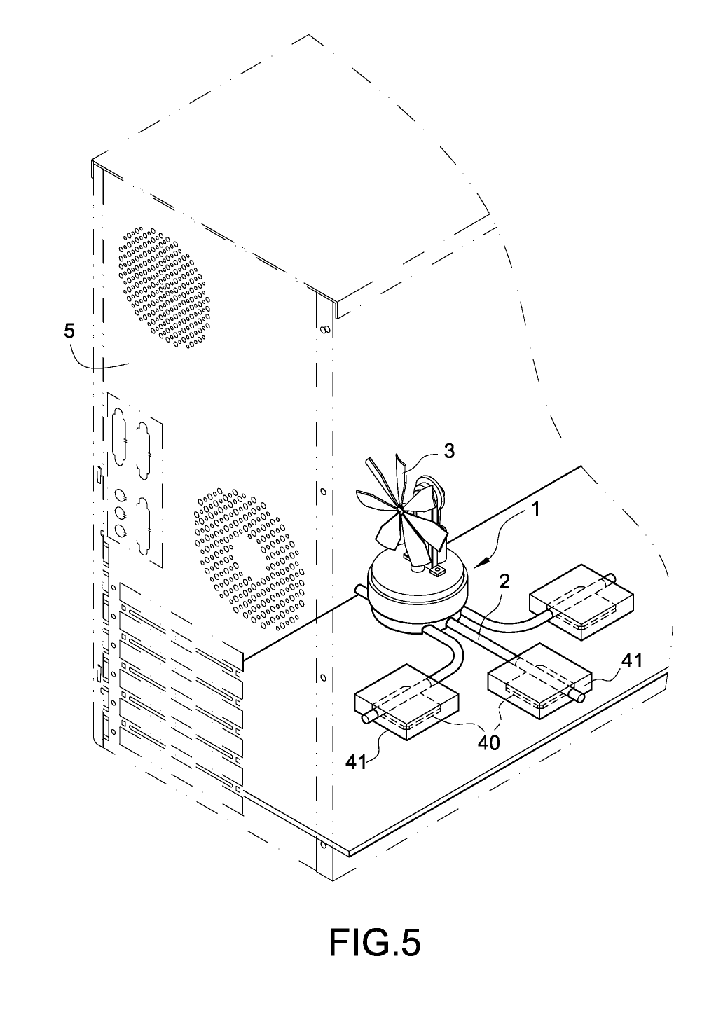

Further, as shown in FIG. 5, the heat power device can be applied to a computer casing 5. The heat generated by the CPU of the computer or the electronic heat-generating element 40 (e.g. south and north bridges) is used to drive the Stirling engine 1 to operate. In practice, a plurality of heat-dissipating plates 41 can be adhered onto the electronic heat-generating element 40 to absorb the generated heat. Further, the end 20 to be heated of each heat pipe 2 is provided on the heat-dissipating plate 41 and thermally connected thereto. When the heat generated by each electronic heat-generating element 40 is transferred to the surface 105 to be heated of the Stirling engine 1 via each heat pipe 2, the Stirling engine 1 can drive the blade 3 to rotate to generate an air flow within the computer casing 5, thereby to solve the greenhouse effect in the computer casing 5.

Therefore, with the heat power device of the present invention, the heat pipe is used to absorb the heat generated by the electronic heat-generating element and rapidly transfers the heat to the Stirling engine 1, thereby to drive the Stirling engine 1 to operate. In this way, the heat generated by the electronic heat-generating element can be used to drive the Stirling engine, so that the Stirling engine is driven to cause the rotation of the blade, thereby to achieve the heat dissipation without the conventional electric fans.

According to the above, the present invention indeed achieves the desired effects and solves the drawbacks of prior art. Further, the present invention really has novelty and inventive steps and thus conforms to the requirements for a utility model patent.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A heat power device, comprising:
a Stirling engine having a piston seat, the interior of the piston seat formed with a hollow chamber for accommodating a piston therein, the piston connected with a connecting-rod means, the connecting-rod means further connected to a crankshaft, the reciprocal movement of the piston within the chamber driving the connecting-rod means to rotate the crankshaft; and
a heat pipe having an end to be heated and a condensed end far from the end to be heated,
wherein the piston seat has a surface to be heated, the condensed end of the heat pipe is brought into contact with the surface to be heated, thereby to drive the Stirling engine to operate when the end to be heated of the heat pipe is brought into contact with a heat source.

2. The heat power device according to claim 1, wherein the front end of the crankshaft of the Stirling engine is provided with a blade.

3. The heat power device according to claim 1, wherein surface to be heated of the Stirling engine is provided with a trough to correspond to the condensed end of the heat pipe, and the condensed end of the heat pipe is embedded in the trough.
